(19) United States
(12) Patent Application Publication
(10) Pub. No.: US 2017/0300995 A1
(43) Pub. Date: Oct. 19, 2017

(54) SYSTEM AND METHOD TO OPTIMIZE CLUSTER INVENTORY

(71) Applicant: Google Inc., Mountain View, CA (US)

(72) Inventors: Zhongyu Wang, Millbrae, CA (US); Chun How Tan, Mountain View, CA (US); Hrishikesh Balkrishna Aradhye, Mountain View, CA (US); Kara Bailey, Menlo Park, CA (US); Fei Hong, Issaquah, WA (US); John Mentgen, San Carlos, CA (US); Sebastian Camacho, San Francisco, CA (US); Zhaoyan Su, Santa Clara, CA (US); Aaron Kwong Yue Lee, Palo Alto, CA (US); Xun Zhang, Palo Alto, CA (US)

(21) Appl. No.: 15/099,136

(22) Filed: Apr. 14, 2016

(51) Int. Cl. G06Q 30/06; G06F 17/30

(52) U.S. Cl. CPC G06Q 30/0631; G06F 17/30601; G06Q 30/0643

(57) ABSTRACT

A system and method for optimizing clusters included in an app store are disclosed. The method comprises generating, by one or more proposal servers, one or more cluster proposals, wherein each of the one or more proposal servers executes a proposal algorithm, processing, by a cluster server, the one or more cluster proposals to resolve any conflicts within and across the one or more proposal servers, assigning a priority value to each of the one or more cluster proposals based on a predicted impact of the respective cluster proposal in the app store, forwarding to a review portal a predetermined amount of prioritized cluster proposals for review and approval, and publishing approved prioritized clusters proposals on the app store.

### BACKGROUND

App store merchandising has traditionally been done through manual creation. Apps that seem appropriate for a user may be identified and presented as a group, or cluster. An application cluster may be a group of applications grouped based on a particular attribute. Recommendations for clusters of apps and other digital media for app store users are generated algorithmically, by merchandisers of the app store, and/or by developers. These methods, although they can provide good quality clusters, may include inappropriate items that are not suitable for promotion and/or do not provide enough clusters or cluster diversity.

Discovering the right app for a cluster remains challenging for app store publishers. App stores attempt to provide a premium product with highly curated yet deeply personalized content. Accordingly, maintaining fresh application clusters is of the utmost importance to the store publisher and to the users of the app store.

### BRIEF SUMMARY

According to an embodiment of the disclosed subject matter, a method for optimizing clusters included in digital distribution service is disclosed. The method comprises generating, by one or more proposal servers, one or more cluster proposals, wherein each of the one or more proposal servers executes a proposal algorithm, processing, by a cluster server, the one or more cluster proposals to resolve any conflicts within and across the one or more proposal servers, assigning a priority value to each of the one or more cluster proposals based on a predicted impact of the respective cluster proposal in the digital distribution service, forwarding to a review portal a predetermined amount of prioritized cluster proposals for review and approval, and publishing approved prioritized clusters proposals on the digital distribution service.

In an aspect of the embodiment, the method further comprising determining a predicted impact of each of the one or more cluster proposals based at least on one or more performance metrics associated with at least one of a cluster and digital item included in a proposed cluster.

In an aspect of the embodiment, the cluster proposal may be one of adding a cluster, removing a cluster, adding a digital item to a cluster, removing a digital item from a cluster, and merging multiple clusters.

In an aspect of the embodiment, the method further comprises automatically forwarding cluster proposals that meet a predetermined threshold.

In an aspect of the embodiment, the method further comprises receiving at the one or more proposal servers feedback information to adjust the one or more proposal algorithms to adjust the algorithm based on the received feedback information, wherein the feedback information includes at least one of the approval or disapproval of the cluster proposal in the review portal, performance of a cluster updated by a cluster proposal; and performance of digital item included in an updated cluster.

In an aspect of the embodiment, the priority value is based at least in part on the determined predicted impact.

In an aspect of the embodiment, publishing the approved cluster proposals comprises updating a cluster in accordance with the cluster proposal and displaying, via the digital distribution service, the updated cluster.

In an aspect of the embodiment, the method further comprises automatically publishing one or more cluster proposals that are generated from a trusted proposal server.

In an aspect of the embodiment, the method further comprises monitoring a performance of digital items and clusters in the digital distribution service to detect anomalies, and forwarding to at least one of the one or more proposal servers a detected anomaly to generate at least one cluster proposal based on the anomaly.

In an aspect of the embodiment, the prioritized cluster proposals are displayed in a user interface of the review portal based on the priority.

According to an embodiment of the disclosed subject matter, a system for optimizing clusters in a digital distribution service is disclosed. The system comprises a cluster engine, including one or more proposal servers, configured to generate one or more cluster proposals, wherein each of the one or more proposal servers executes a proposal algorithm, process the one or more cluster proposals to resolve any conflicts within and across the one or more proposal servers, assign a priority value to each of the one or more cluster proposals based on a predicted impact of the respective cluster proposal in the digital distribution service, and forward to a review portal a predetermined amount of prioritized cluster proposals for review and approval. The system further includes a publisher, including a processor, configured to publish approved prioritized cluster proposals on the digital distribution service.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example network and system configuration according to an embodiment of the disclosed subject matter;

FIG. 2 shows an example system architecture of the cluster optimization system in accordance with an implementation of the disclosed subject matter;

FIG. 3 shows an example block diagram of the cluster optimization system in accordance with an implementation of the disclosed subject matter;

FIG. 4 shows an example flow diagram of the cluster optimization system in accordance with an implementation of the disclosed subject matter; and

FIG. 5 shows a computing device according to an implementation of the disclosed subject matter.

### DETAILED DESCRIPTION

Digital media in a digital distribution server/service, e.g., an app store, may be categorized by the distribution service, publisher, or by the developer when the digital media is published to the app store. Again, an application cluster may be a group of applications grouped based on a particular attribute. For example, applications may be grouped in one of two application categories “education” and “games”. In this case, the two application clusters include applications with application category “education” and “games”, respectively.

In accordance with an implementation of the present subject matter, a system and method are disclosed that generates and optimizes clusters that are displayed to users through the digital distribution service, such as an app store. The disclosed system and method utilize feedback from both merchandisers of the app store, and users of the app store to update, delete, and create digital media item clusters that are displayed to users in the app store. For example, when a new app is added to the app store, the system may propose that the new app be added to one or more clusters. Each cluster proposal made by the system may be evaluated for its predicted impact and prioritized for review by a merchandiser. For those cluster proposals that meet a certain criteria, the cluster proposal is automatically processed for publishing to the app store and displaying to users of the app store. For those cluster proposals that may not meet the certain criteria, the cluster proposal is forwarded to a merchandiser/review portal for review and approval or disapproval. If approved, the cluster proposal is processed and published to the app store.

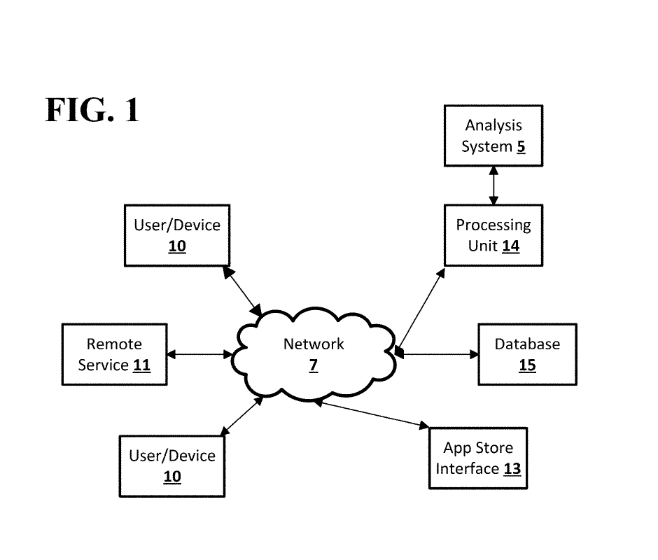

FIG. 1 shows an example arrangement according to an embodiment of the disclosed subject matter. One or more devices or systems 10, 11, such as remote services or service providers 11, user devices 10 such as local computers, smart phones, tablet computing devices, and the like, may connect to other devices via one or more networks 7. The network may be a local network, wide-area network, the Internet, or any other suitable communication network or networks, and may be implemented on any suitable platform including wired and/or wireless networks. The devices 10, 11 may communicate with one or more remote computer systems, such as processing units 14, databases 15, and user interface systems 13. In some cases, the devices 10, 11 may communicate with a user-facing interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to a web browser client on a user device 10, and a computer-readable API or other interface is provided to a remote service client 11.

The user interface 13, database 15, and/or processing units 14 may be part of an integral system, or may include multiple computer systems communicating via a private network, the Internet, or any other suitable network. One or more processing units 14 may be, for example, part of a distributed system such as a cloud-based computing system, search engine, content delivery system, or the like, which may also include or communicate with a database 15 and/or user interface 13, for example, an app store user interface. In some arrangements, an analysis system 5 may provide back-end processing, such as where stored or acquired data is pre-processed by the analysis system 5 before delivery to the processing unit 14, database 15, and/or user interface 13. For example, a digital distribution server/service (e.g., app store, for example Google Play®, Apple App Store®) 5 may provide various digital media items (digital items), for example, apps, clusters, documents, digital music, and the like to one or more other systems 13, 14, 15. In an implementation, the digital distribution interface 13 may be presented to a user at a user device, such as a device 10.

For purposes of this disclosure, an app store will be used throughout as an example digital distribution service. Although an app store will be used, a digital distribution service may be any digital service that distributes to users digital media items, including, for example, apps, documents, digital music, digital books, and the like. Example digital distributions services may include digital music service/stores (e.g., iTunes®), digital document service/store, digital books, digital media stores (e.g., Netflix®), and the like.

Also, digital media items may include items such as ebooks, digital music, digital videos, apps, software, and the like. In this disclosure, apps will be used for purposes of exemplifying an implementation of the present subject matter. Although apps will be used, it should be noted that the present subject matter may be implemented using one or more digital media items.

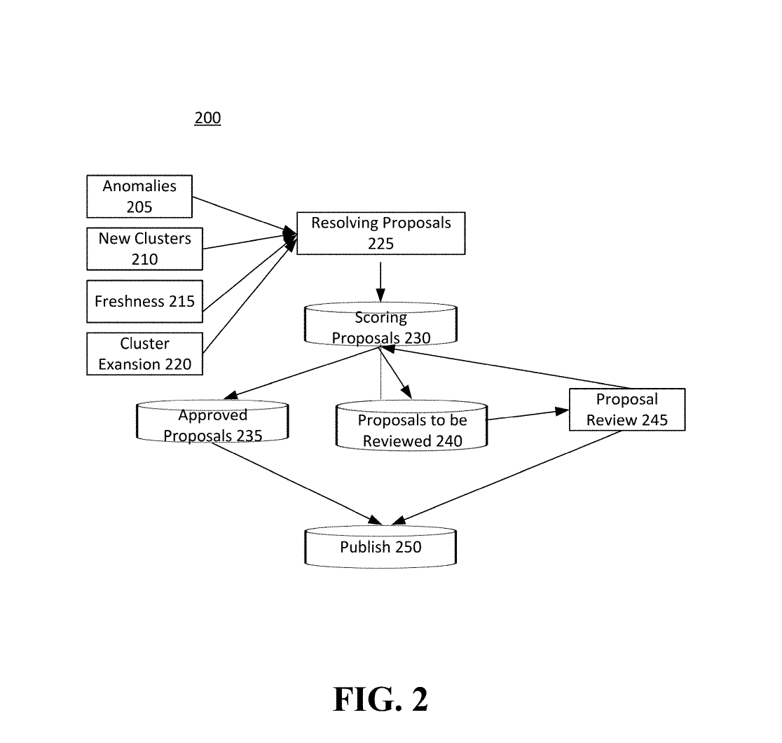

FIG. 2 is an example system architecture of the cluster optimization system 200 in accordance with an implementation of the disclosed subject matter. The system 200 may combine output of one or more proposal algorithms, for example, Anomalies 205, New Clusters 210, Freshness 215, and Cluster Expansion 220. The resulting cluster proposals are resolved to remove risks 225 and scored 230 to generate final cluster proposals, including proposals to be reviewed 240 and proposals that are auto-approved 235. Approved cluster proposals may then be published 250.

As disclosed new proposals may be generated to remove bad clusters/apps identified through anomalies detection 205, add new clusters from other systems/services 210; freshen up clusters with fresh apps 215; and expand clusters with newly identified apps 220.

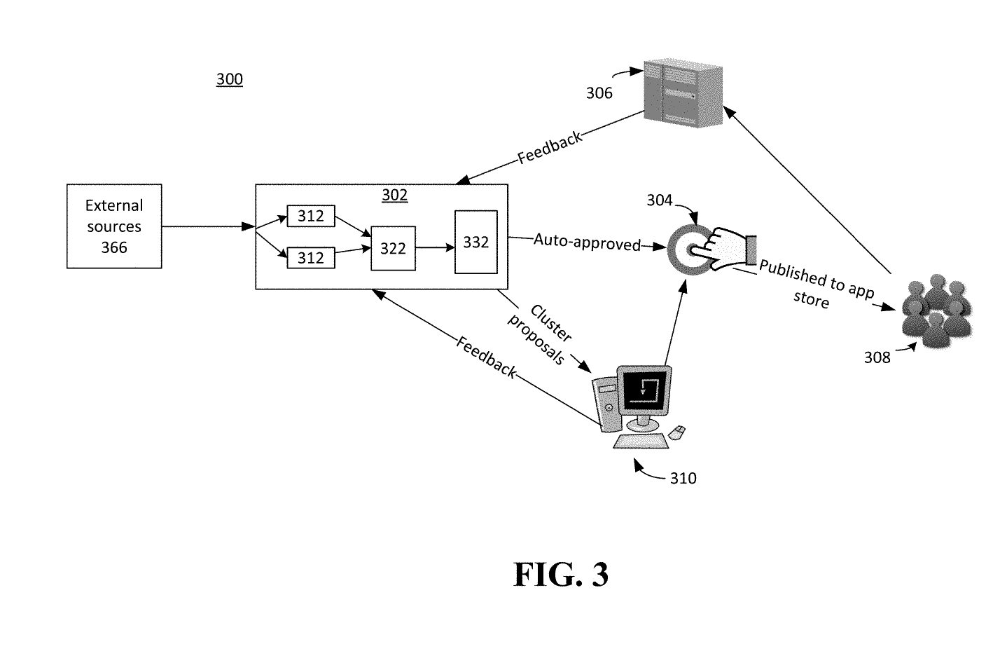

FIG. 3 shows an example block diagram of the cluster optimization system 300 arrangement included in an app store in accordance with an implementation of the disclosed subject matter. The cluster optimization system 300 comprises a cluster engine/server 302, a merchandiser/review portal 310, a monitoring engine 306 and a publisher 304. The cluster engine 302 may include one or more computing devices that may receive, generate and prioritize ideas to optimize app clusters. In accordance with an implementation, the cluster engine 302 comprises one or more pipelines/pipeline servers 312, a proposal generator/server 322 and a priority generator/server 332. The pipelines 312 include algorithms that are used to select apps/clusters that may be considered by the proposal generator 322 to generate cluster proposals. For example, a pipeline may evaluate the apps in the app store to determine which app/doc/cluster is new. Those apps/clusters that are determined to be new, the pipeline 312 may select the new app/cluster and forward the app/doc/cluster to the proposal generator 322. For example, if an app called “Ride” is new to the app store, the pipeline 312 may identify the “Ride” app to be considered for inclusion in a current or new cluster.

Another example pipeline 312 may include a review of all of the apps and clusters in the app store and may select an app or cluster that should be reviewed to determine if there are any similar apps and/or clusters within the app store.

Apps and/or clusters may also be identified for the proposal generator 322 by the monitoring engine 306. As will be disclosed below, the monitoring engine 306, may identify an app and/or cluster that may be an anomaly within a cluster and/or within the entire app store. For example, an app may be performing very well within the app store, and therefore would be identified by the monitoring engine 306 as an anomaly. The identified anomaly (app or cluster) may then be forwarded to the proposal generator 322 for processing. The anomaly may be identified based on performance metrics that are monitored by the monitoring engine 306. Accordingly, well performing apps/clusters as well as underperforming apps/clusters may be identified by the monitoring engine 306, and then may be forwarded to the cluster engine 302. Any anomaly detection algorithm known to persons of ordinary skill in the art may be used to identify apps and/or clusters to be considered by the proposal generator 322.

The monitoring engine 306 also monitors the clusters to provide performance metrics related to the content and performance of the clusters in the app store. The monitoring engine 306 may monitor what is inside each cluster and how well each cluster is performing, where the performance of a cluster is a function (e.g., mean or median) of the performance of each app (e.g., sales popularity) in the cluster. This information may be sliced by different dimensions as well. For example, the information may be sliced by region, corpus page, category, verticals, etc.

In an implementation, the cluster engine 302 may receive requests from external sources 366. The external sources 366, for example, external teams, merchandisers, developers, and the like, may identify criteria that may be input to the proposal generator 322 for use in the generation of cluster proposals. For example, an external source 366 may request that a cluster be generated for an app that includes similar and “family friendly” apps. This criteria from the external source 366 may then be used by the proposal generator 322 to generate cluster proposals, to be disclosed below, that fit within the criteria provided. The external source 366 may also identify an app, document or cluster, to be used to generate one or more cluster proposals including the identified app/document/cluster.

Identified apps and/or clusters and related data are forwarded to the proposal generator 322 by the respective pipeline 312, external sources 366, and/or monitoring engine 306. The proposal generator 322 may include a processor that executes one or more cluster algorithms that identify one or more cluster proposals to update or delete an existing cluster, and/or generate a new cluster. The cluster algorithms may match apps to clusters or a cluster to other clusters and produce one or more cluster proposals. Cluster algorithms may differ in what constitutes a cluster, including the parameters that are set for each algorithm. For example a cluster algorithm may use connectivity-based clustering algorithms, centroid-based clustering algorithms, distribution-based clustering algorithms, or the like, to determine a matching cluster.

In an implementation, each cluster algorithm may produce more than one cluster proposal for each identified app/cluster. Each cluster proposal of the respective cluster algorithms may be processed by the proposal engine 322 to ensure that duplicate proposals or self-conflicting proposals (for example, proposing adding an app into cluster “x”, as well as, a conflicting proposal that includes removal of cluster “x” removal from the app store) are prevented.

Each cluster algorithm may annotate cluster proposals with metadata denoting the cluster algorithm that generated the proposal, and any metadata that could be useful to be provided to the review portal 310 where proposals may be reviewed by a merchandiser of the app store, for example.

In an implementation, each cluster proposal may be categorized as one of five possible proposal types: Add cluster, Remove cluster, Add app into cluster, Remove app from cluster, and Merge two clusters.

To optimize each of the cluster algorithms included in the proposal generator 322, each cluster algorithm may be trained using feedback from the review portal 310 and/or app store users 308, to be disclosed below. Training may also involve machine learning, and adjustment of algorithm parameters (e.g., number of expected clusters) by an operator. In an implementation, one or more of the cluster algorithms may be identified as “Trusted” to consistently produce cluster proposals that perform effectively in the app store. Cluster proposals that are generated by those proposal algorithms that are “Trusted” may be auto-approved for publishing to the app store.

The one or more cluster proposals that are generated by the proposal generator 322 may be prioritized by the priority generator 332 for review in the review portal 310 or publishing by the publisher 304. The priority generator 332, coupled to the proposal generator 322, the publisher 304 and the review portal 310, may receive a cluster proposal from the proposal generator 322 and determine a predicted impact of the proposed cluster in the app store. The goal of the predicted impact is to determine the expected effectiveness of the updated/new/merged cluster, including its impact on the app store user(s) 308.

In an implementation, the priority generator 332 may execute an algorithm that utilizes one or more performance metrics to determine the predicted impact. The performance metrics, computed by the monitoring engine 306, may include one or more of acquisitions, engagement (app usage data), click-through-rate (whether a user clicks the app when they see it in the app store), conversion rate (whether a user installs the app when seen in the app store) etc. The performance metric(s) may be included with the identified app, via metadata, for example, or provided to the priority generator 332 by the monitoring engine 306.

Each performance metric may be collected and combined to generate an ultimate score using linear or non-linear combination of the performance metrics, for example. Weights applied to the linear/non-linear combination may be manually tuned by an operator using trial and error, or tuned through machine learning. The machine learning method(s) may obtain training data based on usage info of apps from previous days, which may be used to train a model to optimize weights for the expected impact using a regression method, for example. It should be noted that training the model may be accomplished using other methods that are well known in the art that will provide optimal weights to be applied to the performance metrics.

The predicted impact score may be defined as the predicted weighted average cluster acquisition rate (CAR) gain of an app cluster. In an implementation, this may be accomplished using multiple scorer algorithms computing different types of scores, and then combining the scores using a configurable score combiner. It is preferred that a scoring component of the priority generator 332 be configurable to allow the final score to be adjusted to boost/demote certain type of cluster proposals. For example it may be desirable to boost important or time-critical proposals (based on freshness or anomaly information); boost less relevant proposals to avoid the system not producing proposals for review; and boost a cluster to avoid starvation of a specific proposal algorithm.

In an implementation, the determination of the predicted impact may be used by the priority generator 332 to prioritize each cluster proposal. For example, those cluster proposal that may be determined to have a high impact once published may be given a high priority, and vice versa. Alternatively, cluster proposals that are deemed to have such high predicted impact may be assigned a low priority so that the higher priority cluster proposals can be reviewed in the review portal 310 first. The priority that is assigned by the priority generator 332 provides a merchandiser with prioritized cluster proposals so that the merchandiser can review the K most promising proposals, or K proposals with sufficiently high priority values, K being a predetermined number of cluster proposals to be reviewed in a certain time period, for example. The predetermined number of cluster proposals may be an absolute number set by a merchandiser, for example, or a varying number that may change based on some criteria. In an implementation, the value of K may depend on the number of proposals needed to ensure that the app store remains fresh for the app store users 308.

The priority assigned to the cluster proposal also be used by the cluster engine 302 to auto-approve and forward a respective cluster proposal directly to the publisher 304 for publishing to the app store. For example, if a doc/app has a lot of acquisitions/engagements in a given country, the cluster proposal including the app may be auto-approved. Similarly, those cluster proposals including apps having very low acquisitions/engagements in a given country, the cluster proposal can be auto-rejected for the respective country.

As indicated above, “Trusted” proposal algorithms may be auto-approved and therefore, the cluster proposals from the “Trusted” proposal algorithms may be forwarded directly to the publisher 304 without being reviewed.

In an implementation, feedback may be provided to the cluster engine 302 from the monitoring engine 306 and the review portal 310. The monitoring engine 306 includes one or more computing devices that monitors the effectiveness and performance of content in the app store, including clusters. The for example, users of the app store and merchandisers. This feedback may be utilized by the cluster engine 302 to adaptively generate optimum app clusters.

For example if a merchandiser disapproves of a cluster proposal generated by the cluster engine 302, the cluster engine 302 may receive the disapproval indication from the review portal 310 and incorporate this feedback into its decision process for prioritizing a cluster proposal. For example, if the cluster engine forwards a proposal of clustering a sports news app with a healthy living app cluster and the merchandiser reviewing the cluster proposal determines that the cluster proposal may not be a good one, the cluster engine 302 may receive the merchandiser's decision, incorporate the feedback into the appropriate algorithm that generated the proposal, such that the algorithm may no longer generate a cluster proposal that combines a healthy living app cluster with a sports news app.

Similarly, feedback from the monitoring engine 306 may be utilized by the cluster engine. As disclosed above, the performance of an updated cluster is monitored by the monitoring engine to evaluate the effectiveness of the cluster to the app store users. If an updated cluster is effective, the idea engine may incorporate this information in the decision process for generating cluster ideas. In the example above, if an updated cluster related to healthy living apps included a sports news app, and the sports news app was never selected by users that were displayed this cluster, or feedback was provided to the app store that indicated that the addition of the sports news app was not useful for the healthy living cluster, the algorithm(s) of the proposal generator that produce the cluster proposal may utilize that information to train the respective algorithm to no longer generate a cluster proposal that combines a healthy living app cluster with a sports news app, for example.

The review portal 310, coupled to the cluster engine 302 and the publisher 304, is configured to provide a reviewer, for example, a merchandiser that assists with operating the app store, with an interactive user-interface (UI) to view, review and approve/disapprove of the cluster proposals that are generated by the cluster engine 302. As disclosed above, the cluster engine 302 forwards prioritized cluster proposals so that the merchandiser can review the K most promising proposals; K being a predetermined number of cluster proposals to be reviewed in a certain time period, for example. The review portal 310 receives the one or more cluster proposals from the cluster engine 302 and displays the proposed cluster to the merchandiser via the UI.

As disclosed, in an implementation, the proposal algorithms may include metadata that may be useful to the merchandiser during review. For example, the metadata may relate to performance metrics for the apps and/or cluster, predicted impact of the proposed cluster, etc. This metadata may be used by the merchandiser to determine whether the proposed cluster should be published. Those cluster proposals that are approved are forwarded to the publisher for publishing to the app store. Those cluster proposals that are disapproved may be stored in storage for re-review

The publisher 304 may include one or more servers that publish the proposed clusters to the app store for display to the app store users 308. The publisher 304 receives the approved cluster proposals from the cluster engine 302, i.e., auto-approved cluster proposals, and the review portal 310, i.e., merchandiser approved cluster proposals. In an implementation, a batch chron job will be executed regularly that publishes updates to the clusters based on the received cluster proposals. An event-triggered publishing for identified cluster proposals may also be executed when waiting for the batch publication is not appropriate. For example, cluster proposals that include time sensitive relevance may require immediate publication in order to achieve maximum impact in the app store.

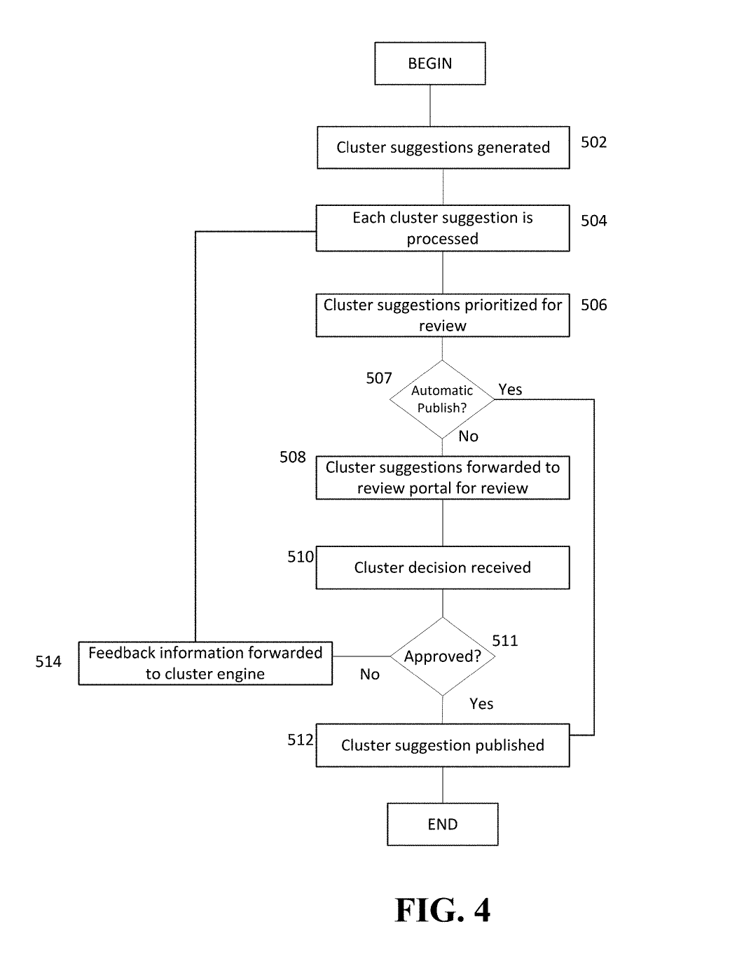

An example flow diagram of an implementation of the disclosed subject matter is shown in FIG. 4. One or more algorithmic pipelines may generate a plurality of cluster suggestions (502). For example, a cluster suggestion may include an update to a cluster, addition to a cluster, deletion of an app from a cluster, or creation of a new cluster. Each of the generated cluster suggestions are forwarded to the cluster engine for processing each cluster to resolve any conflicts within and across sources, for example (504). The processing of each cluster suggestion may also include the collection of all information relating to the cluster, for example, performance metrics, category associated with the app, etc.

The cluster engine may then prioritize each of the cluster suggestions based on the respective predicted impact of the cluster suggestion (506). For example, a cluster suggestion that will have a big impact on a cluster will be assigned the highest priority. For instance, in a “get a ride” cluster, the addition of an app, such as, Uber®, will result in a high priority because of the impact that this popular app would have on the effectiveness of the cluster on the app store users.

During prioritization of the cluster suggestions, a determination (507) is made as to whether the cluster suggestion meets the automatic publish criteria. If so, the cluster suggestion is forwarded to the publish engine for updating of the identified cluster, and display to the user (512).

For those cluster suggestions that do not meet the automatic publish criteria, the cluster suggestion is forwarded to a review portal for additional review (508). A cluster decision is received from a merchant at the review portal (510) indicating whether the cluster suggestion is approved or disapproved (511).

For those cluster suggestions that were approved, the cluster suggestion may be forwarded to the publish engine for updating of the identified cluster in accordance with the suggestion, and displayed to the user (512). For those clusters that were not approved, feedback information relating to the disapproval is forwarded to the cluster engine, where the feedback information may be used by one or more of the suggestion algorithms (514).

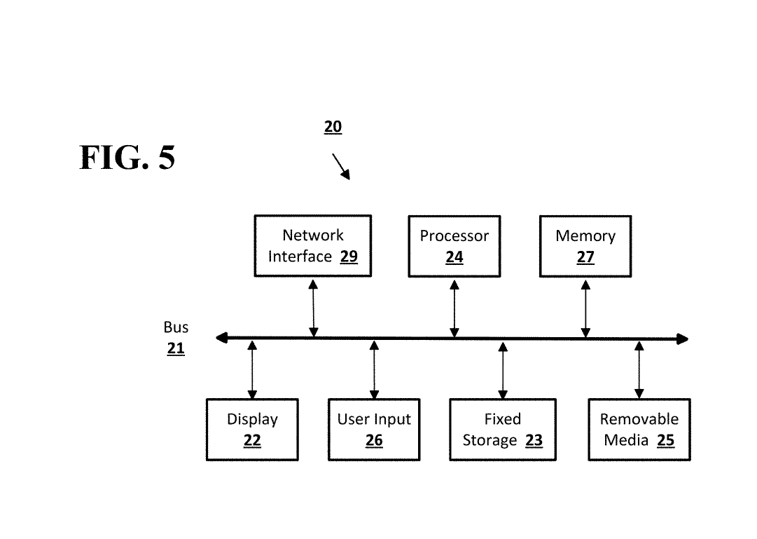

Embodiments of the presently disclosed subject matter may be implemented in and used with a variety of component and network architectures. FIG. 5 is an example computing device 20 suitable for implementing embodiments of the presently disclosed subject matter. Instantiations of device 20 may be used to implement the functionality of some or all of cluster engine 302, review portal 310, monitoring engine 306, and publisher 304, respectively. The device 20 may be, for example, a desktop or laptop computer, or a mobile computing device such as a smart phone, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth(®), near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras and so on). Conversely, all of the components shown in FIG. 6 need not be present to practice the present disclosure. The components can be interconnected in different ways from that shown. The operation of a computer such as that shown in FIG. 6 is readily known in the art and is not discussed in detail in this application. Code to implement the present disclosure can be stored in computer-readable storage media such as one or more of the memory 27, fixed storage 23, removable media 25, or on a remote storage location.

Various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method for optimizing clusters included in an digital distribution service, the method comprising:
generating, by one or more proposal servers, one or more cluster proposals, wherein each of the one or more proposal servers executes a proposal algorithm;
processing, by a cluster server, the one or more cluster proposals to resolve any conflicts within and across the one or more proposal servers;
assigning a priority value to each of the one or more cluster proposals based on a predicted impact of the respective cluster proposal in the digital distribution service;
forwarding to a review portal a predetermined amount of prioritized cluster proposals for review and approval; and
publishing approved prioritized clusters proposals on the digital distribution service.

2. The method of claim 1, further comprising determining a predicted impact of each of the one or more cluster proposals based at least on one or more performance metrics associated with at least one of a cluster and a digital item included in a proposed cluster.

3. The method of claim 2, wherein the cluster proposal may be one of adding a cluster, removing a cluster, adding a digital item to a cluster, removing a digital item from a cluster, and merging multiple clusters.

4. The method of claim 2, further comprising automatically forwarding cluster proposals that meet a predetermined threshold.

5. The method of claim 2, further comprising receiving at the one or more proposal servers feedback information to adjust the one or more proposal algorithms to adjust the algorithm based on the received feedback information, wherein the feedback information includes at least one of the approval or disapproval of the cluster proposal in the review portal, performance of a cluster updated by a cluster proposal; and performance of a digital item included in an updated cluster.

6. The method of claim 2, wherein the priority value is based at least in part on the determined predicted impact.

7. The method of claim 3, wherein publishing the approved cluster proposals comprises updating a cluster in accordance with the cluster proposal and displaying, via the digital distribution service, the updated cluster.

8. The method of claim 7, further comprising automatically publishing one or more cluster proposals that are generated from a trusted proposal server.

9. The method of claim 1, further comprising:
monitoring a performance of digital items and clusters in the digital distribution service to detect anomalies; and
forwarding to at least one of the one or more proposal servers a detected anomaly to generate at least one cluster proposal based on the anomaly.

10. The method of claim 2, wherein the prioritized cluster proposals are displayed in a user interface of the review portal based on the priority.

11. A system for optimizing clusters in a digital distribution service, the system comprising:
a cluster engine, including one or more servers, configured to:
generate one or more cluster proposals, wherein each of the one or more proposal servers executes a proposal algorithm;
process the one or more cluster proposals to resolve any conflicts within and across the one or more proposal servers;
assign a priority value to each of the one or more cluster proposals based on a predicted impact of the respective cluster proposal in the digital distribution service; and
forward to a review portal a predetermined amount of prioritized cluster proposals for review and approval; and
a publisher, including a processor, configured to publish approved prioritized cluster proposals on the digital distribution service.

12. The system of claim 11, wherein the cluster engine is further configured to determine a predicted impact of each of the one or more cluster proposals based at least on one or more performance metrics associated with at least one of a cluster and digital item included in a proposed cluster.

13. The system of claim 12, wherein the cluster proposal may be one of adding a cluster, removing a cluster, adding a digital item to a cluster, removing a digital item from a cluster, and merging multiple clusters.

14. The system of claim 12, wherein the cluster engine is further configured to automatically forward cluster proposals that meet a predetermined threshold to the publisher.

15. The system of claim 12, wherein the cluster engine is further configured to receive feedback information to adjust subsequent generated cluster proposals by the one or more proposal algorithms, wherein the feedback information includes at least one of the approval or disapproval of the cluster proposal from the review portal, performance of a cluster updated by a cluster proposal; and performance of a digital item included in an updated cluster.

16. The system of claim 12, wherein the priority value is based at least in part on the determined predicted impact.

17. The system of claim 11, wherein the publisher, when publishing the approved cluster proposal, is configured to:
update a cluster in accordance with the cluster proposal; and
display, via the digital distribution service, the updated cluster.

18. The system of claim 17, wherein the cluster engine is further configured to automatically forward to the publisher one or more cluster proposals that are generated using a trusted proposal algorithm.

19. The system of claim 11, further comprising a monitoring server, including a processor, configured to:
monitor a performance of digital items and clusters in the digital distribution service to detect anomalies; and
forward to the cluster engine a detected anomaly,
wherein at least one cluster proposal is generated by the cluster engine based on the anomaly.

20. The system of claim 12, further comprising a review portal, including a user interface, configured to display the prioritized cluster proposals in the user interface based on the priority.
